(19) United States
(12) Patent Application Publication
(10) Pub. No.: US 2004/0066366 A1
(43) Pub. Date: Apr. 8, 2004

(54) Bag

(76) Inventors: Stefan Jung, Munchen (DE); Christl Lauterbach, Hohenkirchen-Siegertsbrunn (DE)

Correspondence Address: Jeffrey B Stone, Briggs & Morgan, 2400 IDS Center, Minneapolis, MN, 55402, US

(21) Appl. No.: 10/433,816

(22) PCT Filed: Dec. 7, 2001
(86) PCT No.: PCT/DE01/04597

(30) Foreign Application Priority Data
Dec. 7, 2000 (DE) 10060924.4

(51) Int. Cl. G09G 5/00

(52) U.S. Cl. 345/156

(57) ABSTRACT

The invention relates to a bag comprising at least one integrated communication interface, which is used to electrically interconnect a plurality of electric devices contained in said bag, in such a way that data can be transferred between the electric devices.

It is known to integrate electrical devices for data processing and to interconnect them via a communications interface in a piece of clothing, for example a jacket or a pullover.

The integration of interconnected electrical devices for data processing into an item of clothing is also referred to as “wearable electronics”.

Such an item of clothing is intended to make it possible for communication and the provision of information to be ensured at any time and any place by means of the electrical devices in the item of clothing and their interaction with one another and with other external data networks (external communications networks).

Such an item of clothing has in particular the disadvantages explained in more detail below:

As the intention is that the mobile electronics which are integrated into the item of clothing will be available at all times, these electronics must be installed, i.e. integrated, into each item of clothing. This results in high costs as multiple examples of the individual electrical devices have to be provided (for each respective item of clothing which is to have this functionality). For these reasons of costs, such an item of clothing is appropriate only for a special application and, given the currently very high prices of individual electrical devices, is not suitable for the mass market. Changing electrical devices which are usually sewn into the item of clothing or integrated into it in some other way when the item of clothing is changed is a laborious process and reduces the operator convenience and wearing comfort for a user considerably.

It is very laborious to attach input interfaces and output interfaces for inputting and outputting data to an item of clothing. In the event of the item of clothing being a jacket, it is also uncertain at what location on the jacket it is possible to appropriately attach, for example, an (ergonomic) keyboard or a touchpad or a display. Controlling the electrical devices in the item of clothing by speech is also not possible or appropriate in every situation while the item of clothing is being used.

When wireless communication devices are installed in an item of clothing there is also the disadvantage that an antenna which emits radiofrequency electrical signals always has to be attached in the vicinity of the body. This leads to possible damage to the health of the wearer of the item of clothing and can thus deter potential buyers from buying such an item of clothing.

In addition, it is not expedient or even possible to wear such an item of clothing which provides sufficient space for the integration of the required electrical devices in all environmental conditions or in every situation (for example at very high temperatures).

A protective suit for arctic environmental conditions is known from the company Reima™, as described in [1].

The protective suit which is known from [1] has the following electrical devices which are integrated into the protective suit:

a GPS unit (GPS: Global Positioning System),

a mobile telephone,

a radio transmitter unit for automatically transmitting SOS messages when the wearer of the protective suit is unconscious or experiencing severe pain,

an electrocardiograph,

a plurality of acceleration sensors for determining a possible accident,

a heating system,

a computer unit with a display unit and a single operator control key.

The protective suit which is described in [1] has the general disadvantages described above of an item of clothing which is provided with electrical devices.

Furthermore, it is known from [2] to integrate, for example, weave, electrical lines into the fabric of an item of clothing.

Furthermore, in [3] a cloth keyboard is described, i.e. a keyboard with the appearance of a touchpad which has a plurality of layers of conductive fabric.

In addition, [4] contains an overview of different display units, i.e. for example of liquid crystal displays, OLED displays, also referred to as electronic paper and electronic ink.

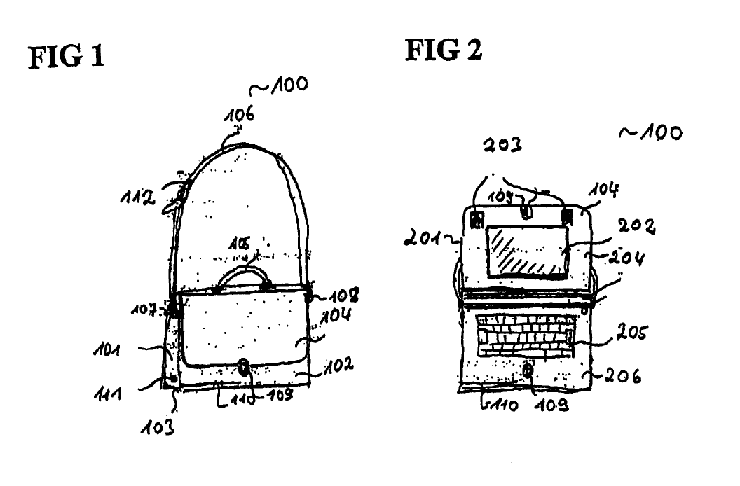

In addition, [5] discloses a communications terminal which is provided for transmitting and receiving communications information and which is integrated into a radio transmitter and/or radio receiver. This terminal has a multiplicity of modules whose functionalities are illustrated symbolically as a block diagram in FIG. 1 of [5].

Furthermore, [6] discloses a transportable data processing system and a case-like briefcase in this respect. The data processing system is composed, according to [6], of a plurality of modular components which are accommodated in one or more compartments of the case-like briefcase in such a way that they can be removed and exchanged. The individual components are connected by means of external cables.

Furthermore, [7] describes an attache case which is equipped with an electrical antitheft protection means and in which an alarm is triggered when it is touched by unauthorized parties.

[8] also discloses a device for making data or binary information from a data carrier, or for example a CD-ROM, visible on a screen and audible.

The invention is based on the problem of specifying an environment of use for interconnecting a plurality of electrical devices for providing mobile communications and information on a personal basis in a way which reduces at least some of the disadvantages described above of the electrical devices integrated in an item of clothing.

The problem is solved by means of the bag having the features according to the independent patent claim.

A bag has at least one communications interface which is integrated into it and by means of which a multiplicity of electrical devices which are contained in the bag can be electrically connected to one another in such a way that, preferably digital, data can be exchanged between the electrical devices.

The bag thus clearly constitutes a portable office with a communications interface which is integrated into the bag, and a communications network which is formed in the bag.

The communications network is implemented according to different exemplary embodiments for example by means of electrical lines which are integrated into the bag and which serve as bus lines of the communications network for transmitting data between the electrical devices, or else by means of radio transmitters and radio receivers which are contained in the bag and have the purpose of transmitting electrical signals and for receiving electrical signals from a first electrical device located in the bag to a second electrical device located in the bag.

The exchange of data between the electrical devices is preferably carried out bidirectionally.

The term “integrated” is to be understood within the scope of this description to the effect that the corresponding integrated elements are part of the bag, for example the respective elements are material which is sewn into the textile material of the bag or even alternatively electrically conductive material which is woven directly into the textile material, for example for electrical lines as described in [2].

A power supply terminal can be integrated into the bag, to which terminal a power supply unit which is contained in the bag, for example an accumulator battery or a battery, can be connected in order to supply power to the electrical devices contained in the bag and connected to the communications interface and to the power supply terminal.

If electrical lines are integrated into the bag, they are connected to the communications interface or to a multiplicity of communications interfaces integrated into the bag, and form a communications network with the latter.

Any desired communications protocol can be used for exchanging data between the electrical devices via the communications network.

Alternatively, the communications network may also be configured as a radio network, in which case a radio transmitter for transmitting electrical signals and a radio receiver for receiving electrical signals transmitted by the radio transmitter are contained in the bag.

The radio transmitter and/or the radio receiver are connected to the communications interface.

It is also possible to use any desired transmission protocol, for example a mobile radio protocol or else a protocol in accordance with “Bluetooth” for transmitting the data via a radio communications network which is formed in the way described above.

In order to increase the data protection and the anti-theft protection of such a bag, access to the bag can be controlled by means of an authentication unit which is additionally integrated into the bag and has the purpose of authenticating a user of the bag.

The authentication unit may be, for example, a fingerprint sensor which is integrated into a lock of the bag.

Alternatively, a unit for speaker verification may be integrated into the bag as an authentication unit.

According to a further refinement of the invention, there is provision that a user of the bag has to carry a radio device, for example a passive transponder chip, on him for authentication purposes, which transponder chip may be integrated, for example, in a wrist watch, and that the lock of the bag generally opens the bag, or permits the electronic devices in the bag to be used, only if the user, i.e. the owner of the radio device and thus the radio device itself is located in the vicinity of the bag so that an appropriate radio link is formed between the transponder chip and the bag. If the radio device is located outside a predefined region around the bag, the electrical devices in the bag cannot be activated and are thus not operationally capable.

According to this refinement, there may also be provision for an alarm unit to be provided which outputs an alarm signal if the radio device is located outside the predefined range of the authentication unit. In this way it becomes possible for the theft of the bag to be signaled to the user of the bag at a very early time.

As will be explained in more detail below, the bag can contain the following electrical devices which are connected to the communications interface or interfaces and thereby to one another:

a mobile telephone,

a GPS unit,

a data memory,

a hand-held computer,

an organizer,

a computer,

a games console,

a data display unit,

a microphone,

a loudspeaker,

a speech recognition unit, and/or

a camera,

etc.

In addition, a keyboard, preferably a cloth keyboard, can be integrated into the bag, as is described for example in [3].

The keyboard may also be configured as a touch-sensitive keyboard.

The individual key elements of the keyboard may have capacitive sensors by means of which it is possible to sense the exertion of a pressure on a key element, which is ultimately interpreted as the activation of a key.

A bag is to be understood, for example, as one of the following types of bag:

a briefcase,

a school bag,

a rucksack,

a case or

a handbag.

The invention can clearly be seen to comprise a bag which is expanded to form a portable communications center, the portable communications center being implemented by integrating a modular electronic information technology system.

The bag thus clearly acts as a carrier for a communications network for connecting the individual modules contained in the bag, i.e. the respective electrical devices, and optionally for a common power supply and for further user interfaces such as, for example, a keyboard or a display unit.

The invention results in particular in the following advantages:

The electrical devices are continuously available.

In addition, in comparison with an item of clothing, the surface of a bag provides more possible ways of integrating a flexible keyboard or a display unit.

The customary operator control elements of a notebook computer, i.e. a customary display unit or a keyboard can be integrated into the lid or onto the front side of a bag.

This refinement of the invention provides a further simplification and a more compact configuration of the bag and thus also a more cost-effective way of manufacturing it and simpler operator control is achieved.

The display unit can be configured as electronic paper, as a liquid crystal display or else as a display unit with OLEDs (organic light emitting diodes) such as are described in, for example, in [4].

A further advantage of the invention is that a bag is usually carried at some distance from the body, for which reason the irradiation of radiofrequency electrical signals via an antenna which is integrated in the bag is usually les problematic compared with the situation in which the electrical radiofrequency signal is emitted directly from an antenna worn on the body. The side of the bag which usually faces the body can additionally have a shield against the electromagnetic radiation.

It is generally to be noted that the bag can be used in a more universal and flexible way than an item of clothing in which the electrical devices are integrated.

Furthermore, the invention makes it more easily possible to protect the electrical devices and the information and data stored in them against theft, for example by means of the additional authentication unit provided according to a refinement of the invention.

In summary, an operator control environment is thus provided which makes available a high degree of data protection and a high degree of anti-theft protection, a high level of operator control convenience and a high level of wearing comfort as well as universal usability and high and continuous availability of the desired information services.

An exemplary embodiment of the invention is illustrated in the figures and will be explained in more detail below. In the figures:

FIG. 1 shows a sketch of a bag according to an exemplary embodiment of the invention;

FIG. 2 shows an outline of the bag from FIG. 1 in a folded-open state; and

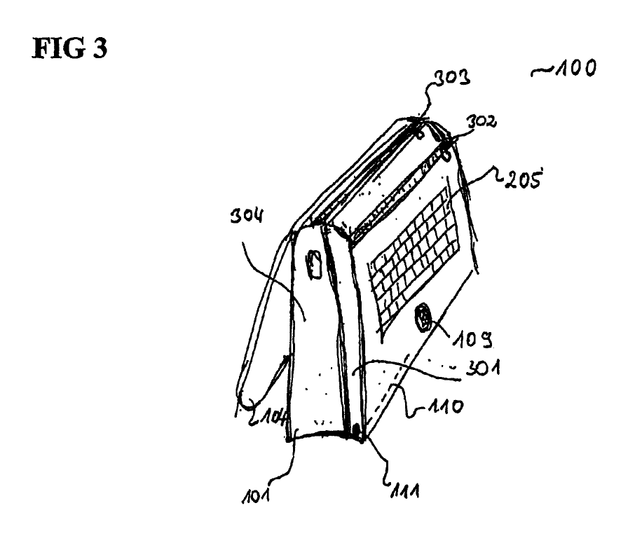

FIG. 3 shows a side view of the bag from FIG. 1 in a folded-open state.

Identical elements are provided with identical reference symbols in the figures.

FIG. 1 shows a bag 100 with two side parts 101, a front side part 102, a bottom element 103 and a folding-open lid element 104 and a carrying handle 105 which is attached to the back of the lid element 104.

In addition, an adjustable shoulder strap 106 is attached to two attachment elements 107, 108 on the side parts 101 of the bag 100.

In addition, a lock 109 is attached to the lid element 104, which lock 109 can be moved into engagement with a second lock element attached to the front side part 102 of the bag 100, and which can thus close the bag 100.

According to this exemplary embodiment, the electronic lock 109 has a fingerprint sensor which opens the lock 109 only when a fingerprint of a predefined user is sensed, and activates the electrical devices which are described below and are contained in the bag 100.

An antenna 110 is integrated into the bag 100 in the bottom region 103.

Furthermore, a mains terminal 111, i.e. a plug connector part for connecting a mains plug into a side part 101 of the bag 100 is integrated.

A headset terminal 112 is attached to the adjustable shoulder strap 106 and connected via an electrical line (not illustrated), provided in the shoulder strap 106, to a communications interface (not illustrated) which is integrated into the bag 100.

Instead of the mains terminal 111 for connecting an external power supply, a battery or an accumulator battery may be contained in an internal compartment of the bag 100 itself and be connected via a corresponding electrical line to the respective electrical devices in order to supply them with power.

According to this exemplary embodiment, a display unit 202, which is embodied as a touch screen, is integrated into the inside 201 of the lid element 104. The display unit 202 is essentially provided in the center of the inside 201 of the lid element 104 of the bag 100 (cf. FIG. 2).

Two loudspeakers 203 are provided in an edge region 204 of the inside of the lid element 104.

A keyboard 205 is provided on an outer side of a first compartment 301 in which electrically conducting lines are integrated.

According to this exemplary embodiment, receptacle compartments (not illustrated) for receiving electrical devices, for example a mobile telephone or a hand-held computer with corresponding plug connector parts, are provided in the first compartment 301. In addition, each receptacle compartment is provided with a corresponding communications interface for electrically connecting the respective electrical device held in the receptacle compartment to the electrical lines, i.e. the communications network.

The keyboard 205 is attached to the upper side 206 of the first compartment 301, the lid element 104 and the upper side of the first compartment 301 being of folding design and being capable of being closed by means of a lock 109 so that the lid element 104 covers the entire keyboard 205 in the closed state of the bag 100.

In this way, the lid element 104 serves as a protection for the keyboard 205.

According to this exemplary embodiment, the keyboard 205 is embodied as a touch-sensitive keyboard.

According to one alternative refinement, the keyboard may also be embodied as a cloth keyboard such as is described, for example, in [3].

Furthermore, a first zipper 302 and a second zipper 303 are provided in the bag 100.

The first compartment 301 is closed or opened by means of the first zipper 302.

A plurality of compartments (not illustrated) into each of which electrical devices, according to this exemplary embodiment a mobile telephone, a hand-held telephone and an

In addition, a plurality of communications interfaces are integrated into the bottom element 103 of the bag 100 for connecting and coupling the respective electrical devices to the communications network provided in the side parts 101 and the rear side part of the bag 100.

The communications interfaces can

be embodied either as fixed plug connector parts, for example as a parallel or serial interface, or

as an air interface, for example as an infrared interface, or

as a plug connector part which projects on a cable into the respective receptacle compartment.

FIG. 3 illustrates a second compartment 304 for receiving files or other documents, generally for further nonelectronic equipment.

The second zipper 303 is provided for opening and closing the second compartment 304.

A central processor unit is provided in the bag 100 in order to control the communication of the electrical devices via the communications interfaces and the electrical lines, i.e. the communications network.

In addition, by means of the central processor unit it is possible to determine the respective type of electrical device which is plugged into the receptacle compartment, for example using a predefined identification protocol.

According to one refinement of the invention, what is referred to as Bluetooth technology is used as the technology for such an identification means.

In this case, an infrared interface by means of which the processor unit in the bag 100 can communicate with the respective electrical device which is plugged into a receptacle compartment of the bag 100 is provided as the communications interface.

Alternatively, the respective electrical devices can each be equipped with a transponder chip for identifying them.

According to one alternative embodiment, there is provision for a wireless interface to be integrated into the bag 100 in order to synchronize the electrical devices in the bag 100 with an external apparatus, for example with a personal computer for transmitting data of an electrical device from the bag 100 to the personal computer, or else for transmitting data, for example for setting up a communications link, to a further, external communications terminal.

1. A bag having at least one communications interface which is integrated into the bag and by means of which a multiplicity of electrical devices which are contained in the bag can be electrically connected to one another so that data can be exchanged between the electrical devices.

2. The bag as claimed in claim 1, having a multiplicity of communications interfaces which are integrated into the bag.

3. The bag as claimed in claim 1 or 2, having a power supply terminal which is integrated into the bag and to which a power supply unit which is contained in the bag can be connected in order to supply power to the electrical devices contained in the bag.

4. The bag as claimed in one of claims 1 to 3, having electrical lines which are integrated into the bag and which are connected to the communications interface and form a communications network for exchanging data between the electrical devices.

5. The bag as claimed in one of claims 1 to 4,
having a radio transmitter for transmitting electrical signals, and
having a radio receiver for receiving electrical signals,
the radio transmitter and/or the radio receiver being connected to the communications interface.

6. The bag as claimed in one of claims 1 to 5, having an authentication unit for authenticating a user of the bag.

7. The bag as claimed in claim 6, in which the authentication unit has
a speaker recognition unit, and/or
a fingerprint sensor.

8. The bag as claimed in claim 6 or 7, in which the authentication unit is contained in a lock of the bag.

9. The bag as claimed in one of claims 1 to 8, in which at least some of the electrical devices are configured as one of the following electrical devices provided with means of communication:
a mobile telephone,
a GPS unit,
a data memory,
a hand-held computer,
a computer,
a games console,
a data display unit,
a microphone,
a loudspeaker,
a voice recognition unit and/or
a camera.

10. The bag as claimed in one of claims 1 to 9, having a keyboard which is integrated into the bag.

11. The bag as claimed in claim 10, in which the keyboard
is embodied as a touch-sensitive keyboard, and/or
has capacitive sensors as key elements of the keyboard.

12. The bag as claimed in one of claims 1 to 11, configured as one of the following types of bag:
a briefcase,
a school bag,
a rucksack,
a case or
a handbag.
